(19) United States
(12) Patent Application Publication
(10) Pub. No.: US 2010/0180100 A1
(43) Pub. Date: Jul. 15, 2010

(54) Matrix microprocessor and method of operation

(75) Inventors: Tsung-Hsin Lu, Freemont, CA (US); Carl Alberola, Tustin, CA (US); Rajesh Chhabria, Irvine, CA (US); Zhenyu Zhou, Irvine, CA (US)

Correspondence Address: LAW OFFICES OF MICHAEL M. AHMADSHAHI, 600 ANTON BLVD., STE. 1100, COSTA MESA, CA, 92626, US

(73) Assignee: MAVRIX TECHNOLOGY, INC.

(21) Appl. No.: 12/319,934

(22) Filed: Jan. 13, 2009

(51) Int. Cl. G06F 15/76; G06F 9/30

(52) U.S. Cl. 712/22; 712/32; 712/E09.003

(57) ABSTRACT

A microprocessor includes a direct access memory (DMA) engine which is responsive to pairs of block indices associated with one or more blocks in a first logical plane and transfers the one or more blocks between the first logical plane, a second logical plane, and a physical memory space according to the pairs of block indices. The logical planes represent two dimensional fields of data such as those found in images and videos. The microprocessor further comprises cache memory which updates its content with one or more cache-blocks which are in the neighborhood of the one or more blocks improving the operation of the cache memory by increasing cache hits. The DMA engine may further operate on n-dimensional blocks in a n-dimensional logical space. The microprocessor further includes special-purpose instructions, operative on a single-instruction-multiple-data (SIMD) computation unit, especially tailored to perform matrix operations. The SIMD may share scalar operands with an onboard single-instruction-single-data (SISD) computation unit.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a microprocessor and method of operation for fast processing of two-dimensional data such as images and video. In particular, the present invention relates to a microprocessor which includes a direct memory access (DMA) engine, cache memory, a local instruction memory, a local data memory, a single-instruction-multiple-data (SIMD) computation unit, a single-instruction-single-data (SISD) computation unit, and a reduced set of instructions. The architecture and method of operation of the microprocessor may further be extended to processing of n-dimensional data structures.

### BACKGROUND

The present invention relates to a microprocessor comprising a DMA engine, cache memory, a local instruction memory, a local data memory, an SIMD computation unit, also referred to as the matrix computation unit (MCU), an SISD computation unit, also referred to as the scalar computation unit (SCU), and a reduced set of instructions that are configured to process two-dimensional signals such as those encountered in the field of image and video processing and coding. The microprocessor of the present invention is designed to overcome the limitations of conventional computer architectures by efficiently handling two dimensional (2D) data structures, and outperforms them in cycle efficiency, simplicity, and naturalness of the firmware development. Although, the microprocessor is designed to operate on 2D data blocks, it may be configured to operate on n-dimensional data blocks as well.

The DMA engine of the present invention is responsive to pairs of indices that are associated with data blocks in a logical plane and operates to transfer the blocks between the logical plane, other similar logical planes, and physical memory space according to the pairs of block indices. The cache memory included in the microprocessor is responsive to the transfer of the data blocks. It is configured to update its content with cache blocks which are associated with the data blocks. The cache blocks may be chosen to be in the neighborhood of the data blocks.

The SIMD computation unit is responsive to a set of special-purpose instructions that are tailored to matrix operations and operates to perform such matrix operations upon one or two matrix operands. A set of general purpose matrix registers, included in the microprocessor and coupled with the logical and/or physical memory space, hold the matrix operands. The SISD computation unit is responsive to a set of scalar instructions that are designed to perform scalar operations upon one or two scalar operands. A set of general purpose registers, included in the microprocessor and coupled with the logical and/or physical memory space, hold the scalar operands. The SIMD and SISD are bridged together in such a way so as to allow the SIMD computation unit to receive scalar operands from the SISD computation unit to be utilized in the matrix operations, and allow the SISD to receive scalar operands from the SIMD computation unit to be utilized in the scalar operations.

Several technology areas, including but not limited to digital image and video processing and coding, use many different techniques and algorithms that rely on two-dimensional blocks of data as their basic computation unit. A very clear and significant example is found in the world of video compression. Transmission of digital video requires compression in order to considerably reduce the size of the data to be transmitted. There are many different systems to encode and decode digital video, namely MPEG2, H263, MPEG4, H264 and more. But they all are integrated by a subset of common and basic tools that operate at block level, wherein a block is generally defined as a rectangular set of pixels, small compared to the image size. And given the amount of data to be processed, all of them also result to be highly computationally demanding systems.

Conventional solutions are usually based on single-processor architectures, which are restricted to process one by one the data elements within blocks. That is translated into huge amounts of instructions when large data sets are considered, such as large video frames or images, known to skilled artisans, and thus processors need to run at very high speeds in order to achieve certain execution time requirements. As a result, such solutions typically lead to very low power efficiency, significantly restricting their applicability, for instance, to mobile devices. Furthermore, due to their intrinsic one dimensional (1D) nature, their firmware tends to suffer of significant overhead to handle 2D signals. The present invention overcomes the limitations of conventional computer architectures to efficiently handle 2D data structures, and outperforms them in cycle efficiency, and simplicity and naturalness of the firmware development.

Other alternative solutions use multi-processor architectures, which allow parallel computing and thus reduce the computational load on each of the processors, yet keep the overall power efficiency very low. In addition, the structure of this type of processors is generally complicated to manage, requiring complex firmware just to coordinate tasks between the processors.

Although various systems have been proposed which touch upon some aspects of the above problems, they do not provide solutions to the existing limitations in providing a simple, economical, and efficient means to handle multi dimensional signals. The present inventions offers an efficient alternative to existing technologies by reducing the number of operations required to access and manipulate multi dimensional data.

### SUMMARY

A microprocessor comprises two different computation units, a local instruction memory, a local data memory, a cache memory and a DMA engine. The first computation unit, also referred to as the scalar computation unit (SCU), implements a single-instruction-single-data architecture (SISD) that operates on 32-bit operands. On the other hand, the second computation unit, which is also referred to as the matrix computation unit (MCU), implements a single-instruction-multiple-data architecture (SIMD) that operates on 4×4 matrix operands, whose elements are 16 bits wide each.

Similarly, in addition to a first set of sixteen 32-bit general purpose registers (GPR) which can hold scalar operands, eight additional 4×4 general purpose matrix registers (GPMR) are available in the microprocessor to hold multiple-data operands. Each of the elements in a matrix register is 16-bit wide.

For the microprocessor a reduced set of 32-bit instructions is defined, making it possible to conditionally execute all of them based on sixteen combinations of zero, carry, overflow and negative flags. The instructions can be classified into three different types. The first type of instructions includes those instructions that exclusively operate on scalar operands, either as immediate values or stored in general purpose registers, and generate scalar results as well, stored in general purpose registers. Instructions of this type are executed by the scalar computation unit. The second type of instructions, on the other hand, includes those instructions that exclusively operate on 4×4 matrix operands and generate 4×4 matrix results, all stored in matrix registers. Instructions of this type are executed by the matrix computation unit. Finally, the third type of instructions includes those instructions that operate on combinations of scalar and 4×4 matrix operands and generate either scalar or 4×4 matrix results. Instructions of this last type are also executed by the matrix computation unit, and serve as bi-directional bridge between the first two types of instructions.

The microprocessor implements a five stage pipeline known to artisans of ordinary skill. They are: fetch, decode, execute, memory and write-back. It is during the fetch-decode stages when it is decided the destination computation unit for the fetched instruction, depending on its type. Therefore, only one single instruction is executed at any time instant by only one of the two available computation units, and among the set of 32-bit special purpose registers (SPR) that holds the state of the microprocessor, only one program counter register (PC) is found.

A Harvard architecture, known to skilled artisans, is implemented by the microprocessor, with physically separated storage and signal pathways for instructions and data in form of a local instruction memory and a local data memory. Although Harvard architecture is implemented, the microprocessor of the present invention may implement other architectures such as the von Neumann architecture.

The microprocessor of the present invention provides fast processing of 2D data structures, efficiently accessing (reading and writing) to 2D data structures in the memory. In addition to instructions for regular access to conventional 1D data (8, 16 and 32 bits), the microprocessor provides instructions for low latency access to matrix data via the DMA. Both the cache memory and the DMA engine included in the microprocessor are respectively tailored to speed up the memory access to data blocks, and to efficiently move two-dimensional sets of data blocks between different location in local and external memories.

In one aspect, a microprocessor is disclosed comprising a DMA engine configured to transfer data between physical memory space and one or more logical planes. The DMA engine is responsive to one or more pairs of block indices associated with one or more blocks in a first logical plane and operative to transfer the one or more blocks between the first logical plane, a second logical plane, and a physical memory space according to the one or more pairs of block indices.

In another aspect, a microprocessor is disclosed comprising a DMA engine configured to transfer data between physical memory space and one or more logical planes. The DMA is responsive to one or more pairs of block indices associated with one or more blocks in a first logical plane and operative to transfer the one or more blocks between the first logical plane, a second logical plane, and a physical memory space according to the one or more pairs of block indices. Preferably, the microprocessor is configured such that each of the one or more pairs of block indices corresponds to a horizontal and vertical location of one of the one or more blocks in the first logical plane.

In another aspect, a microprocessor is disclosed comprising a DMA engine configured to transfer data between physical memory space and one or more logical planes. The DMA is responsive to one or more pairs of block indices associated with one or more blocks in a first logical plane and operative to transfer the one or more blocks between the first logical plane, a second logical plane, and a physical memory space according to the one or more pairs of block indices. Preferably, the microprocessor is configured such that the horizontal and vertical location corresponds to one of a block-aligned and a non-block-aligned location. Preferably, a block-aligned location locates an aligned block whose elements are contiguous in the physical memory space, and a non-block-aligned location locates a non-aligned block whose elements are non-contiguous in the physical memory space. In one embodiment, the DMA engine is configured to transfer one or more aligned blocks in the first logical plane to the physical memory space. In another embodiment, the DMA engine is configured to transfer one or more blocks from the physical memory space to one or more aligned blocks in the first logical plane. In another embodiment, the DMA engine is configured to transfer one or more non-aligned blocks in the first logical plane to the physical memory space. In another embodiment, the DMA engine is configured to transfer one or more blocks from the physical memory space to one or more non-aligned blocks in the first logical plane. In another embodiment, the DMA engine is configured to transfer one or more aligned blocks in the first logical plane to one or more non-aligned blocks in the first logical plane. In another embodiment, the DMA engine is configured to transfer one or more aligned blocks in the first logical plane to one or more aligned blocks in the first logical plane. In another embodiment, the DMA engine is configured to transfer one or more non-aligned blocks in the first logical plane to one or more aligned blocks in the first logical plane. In another embodiment, the DMA engine is configured to transfer one or more non-aligned blocks in the first logical plane to one or more non-aligned blocks in the first logical plane. In another embodiment, the DMA engine is configured to transfer one or more aligned blocks in the first logical plane to one or more aligned blocks in the second logical plane. In another embodiment, the DMA engine is configured to transfer one or more aligned blocks in the first logical plane to one or more non-aligned blocks in the second logical plane. In another embodiment, the DMA engine is configured to transfer one or more non-aligned blocks in the first logical plane to one or more non-aligned blocks in the second logical plane. In yet another embodiment, the DMA engine is configured to transfer one or more non-aligned blocks in the first logical plane to one or more aligned blocks in the second logical plane.

In another aspect, a microprocessor is disclosed comprising a DMA engine configured to transfer data between physical memory space and one or more logical planes. The DMA is responsive to one or more pairs of block indices associated with one or more blocks in a first logical plane and operative to transfer the one or more blocks between the first logical plane, a second logical plane, and a physical memory space according to the one or more pairs of block indices. Preferably, the microprocessor is configured such that each of the one or more blocks is a four-by-four-element matrix. In one instance, each element of the four-by-four-element matrix is an eight-bit data.

In another aspect, a microprocessor is disclosed comprising a DMA engine configured to transfer data between physical memory space and one or more logical planes. The DMA is responsive to one or more pairs of block indices associated with one or more blocks in a first logical plane and operative to transfer the one or more blocks between the first logical plane, a second logical plane, and a physical memory space according to the one or more pairs of block indices. Preferably, the microprocessor is configured such that the first logical plane, second logical plane, and physical memory space comprise at least one of an external memory and internal memory.

In another aspect, a microprocessor is disclosed comprising a DMA engine configured to transfer data between physical memory space and one or more logical planes. The DMA is responsive to one or more pairs of block indices associated with one or more blocks in a first logical plane and operative to transfer the one or more blocks between the first logical plane, a second logical plane, and a physical memory space according to the one or more pairs of block indices. Preferably, the microprocessor further comprises cache memory which is responsive to the transfer of the one or more blocks and operates to update its content with one or more cache-blocks associated with the one or more blocks. According to one embodiment, the microprocessor is configured such that the one or more cache-blocks are in the neighborhood of the one or more blocks. Preferably, the neighborhood of one of the one or more blocks comprises 8 blocks adjacent to the one of the one or more blocks in any of the logical planes.

In another aspect, a microprocessor is disclosed comprising a DMA engine configured to transfer data between physical memory space and one or more logical planes. The DMA is responsive to one or more pairs of block indices associated with one or more blocks in a first logical plane and operative to transfer the one or more blocks between the first logical plane, a second logical plane, and a physical memory space according to the one or more pairs of block indices. Preferably, the microprocessor further comprises an instruction memory which includes one or more special-purpose instructions which include one or more matrix operations, and an SIMD computation unit which is responsive to the one or more special-purpose instructions and operates to perform the one or more matrix operations upon at least one of two matrix operands. According to one embodiment, the microprocessor is configured to execute each of the one or more special-purpose instructions in less than or equal to five clock cycles. In one instance, the one or more matrix operations comprise matrix operations performed in at least one of image and video processing and coding. According to one embodiment, the matrix operand is a four-by-four matrix operand whose elements are each sixteen bits wide.

In another aspect, a microprocessor is disclosed comprising a DMA engine configured to transfer data between physical memory space and one or more logical planes. The DMA is responsive to one or more pairs of block indices associated with one or more blocks in a first logical plane and operative to transfer the one or more blocks between the first logical plane, a second logical plane, and a physical memory space according to the one or more pairs of block indices. Preferably, the microprocessor further comprises an instruction memory which includes one or more special-purpose instructions which include one or more matrix operations, and an SIMD computation unit which is responsive to the one or more special-purpose instructions and operates to perform the one or more matrix operations upon at least one of two matrix operands. Preferably, the microprocessor further comprises an instruction memory which includes one or more scalar instructions, and an SISD computation unit which is responsive to the one or more scalar instructions and operates to perform one or more scalar operations upon at least one of two scalar operands. According to one embodiment, the microprocessor is configured such that the SIMD computation unit is further operative to receive scalar operands from the SISD computation unit to be utilized in the one or more matrix operations. In another embodiment, the microprocessor is configured such that the SISD computation unit is further operative to receive scalar operands from the SIMD computation unit to be utilized in the one or more scalar operations.

In another aspect, a microprocessor is disclosed comprising a DMA engine configured to transfer data between physical memory space and one or more n-dimensional logical spaces. The DMA is responsive to one or more n-dimensional block indices associated with one or more n-dimensional blocks in a first n-dimensional logical space and operative to transfer the one or more n-dimensional blocks between the first n-dimensional logical space, a second n-dimensional logical space, and a physical memory space according to the one or more n-dimensional block indices with n greater than two. Preferably, the microprocessor further comprises cache memory which is responsive to the transfer of the one or more n-dimensional blocks and operates to update its content with one or more n-dimensional cache-blocks associated with the one or more n-dimensional blocks.

In another aspect, a microprocessor is disclosed comprising a DMA engine configured to transfer data between physical memory space and one or more n-dimensional logical spaces. The DMA is responsive to one or more n-dimensional block indices associated with one or more n-dimensional blocks in a first n-dimensional logical space and operative to transfer the one or more n-dimensional blocks between the first n-dimensional logical space, a second n-dimensional logical space, and a physical memory space according to the one or more n-dimensional block indices with n greater than two. Preferably, the microprocessor further comprises an instruction memory which includes one or more special-purpose instructions which include one or more operations for n-dimensional data processing, and an SIMD computation unit which is responsive to the one or more special-purpose instructions and operates to perform the one or more n-dimensional data processing upon at least one of two n-dimensional operands.

In another aspect, a microprocessor is disclosed comprising a DMA engine configured to transfer data between physical memory space and one or more n-dimensional logical spaces. The DMA is responsive to one or more n-dimensional block indices associated with one or more n-dimensional blocks in a first n-dimensional logical space and operative to transfer the one or more n-dimensional blocks between the first n-dimensional logical space, a second n-dimensional logical space, and a physical memory space according to the one or more n-dimensional block indices with n greater than two. Preferably, the microprocessor further comprises an instruction memory which includes one or more scalar instructions, and an SISD computation unit which is responsive to the one or more scalar instructions and operates to perform one or more scalar operations upon at least one of two scalar operands.

In another aspect, a method of processing data via a microprocessor is disclosed. The method comprises providing a DMA engine which is responsive to one or more pairs of block indices associated with one or more blocks in a first logical plane, and transferring the one or more blocks between the first logical plane, a second logical plane, and a physical memory space according to the one or more pairs of block indices, via the DMA engine.

In another aspect, a method of processing data via a microprocessor is disclosed. The method comprises providing a DMA engine which is responsive to one or more pairs of block indices associated with one or more blocks in a first logical plane, and transferring the one or more blocks between the first logical plane, a second logical plane, and a physical memory space according to the one or more pairs of block indices, via the DMA engine. Preferably, the microprocessor further comprises cache memory and the method further comprises updating a content of the cache memory with one or more cache-blocks associated with the one or more blocks, via the microprocessor.

In another aspect, a method of processing data via a microprocessor is disclosed. The method comprises providing a DMA engine which is responsive to one or more pairs of block indices associated with one or more blocks in a first logical plane, and transferring the one or more blocks between the first logical plane, a second logical plane, and a physical memory space according to the one or more pairs of block indices, via the DMA engine. Preferably, the method further includes providing an instruction memory comprising one or more special-purpose instructions which include one or more matrix operations, providing an SIMD computation unit which is responsive to the one or more special-purpose instructions, and performing the one or more matrix operations upon at least one of two matrix operands, via the SIMD computation unit. Preferably, the instruction memory further comprises one or more scalar instructions, and the method further comprises providing an SISD computation unit which is responsive to the one or more scalar instructions and performing one or more scalar operations upon at least one of two scalar operands, via the SISD computation unit. According to one embodiment, the method further comprises receiving scalar operands, via the SIMD computation unit from the SISD computation unit to be utilized in the one or more matrix operations. According to yet another embodiment, the method further comprises receiving scalar operands, via the SISD computation unit from the SIMD computation unit to be utilized in the one or more scalar operations.

In another aspect, a method of processing data via a microprocessor is disclosed. The method comprises providing a DMA engine which is responsive to one or more n-dimensional block indices associated with one or more n-dimensional blocks in a first n-dimensional logical space, and transferring the one or more n-dimensional blocks between the first n-dimensional logical space, a second n-dimensional logical space, and a physical memory space according to the one or more n-dimensional block indices, via the DMA engine, wherein n is greater than two.

In another aspect, a method of processing data via a microprocessor is disclosed. The method comprises providing a DMA engine which is responsive to one or more n-dimensional block indices associated with one or more n-dimensional blocks in a first n-dimensional logical space, and transferring the one or more n-dimensional blocks between the first n-dimensional logical space, a second n-dimensional logical space, and a physical memory space according to the one or more n-dimensional block indices, via the DMA engine, wherein n is greater than two. Preferably, the microprocessor further comprises cache memory which is responsive to the transferring of the one or more n-dimensional blocks, and the method further comprises updating a content of the cache memory with one or more n-dimensional cache-blocks associated with the one or more n-dimensional blocks, via the microprocessor.

In another aspect, a method of processing data via a microprocessor is disclosed. The method comprises providing a DMA engine which is responsive to one or more n-dimensional block indices associated with one or more n-dimensional blocks in a first n-dimensional logical space, and transferring the one or more n-dimensional blocks between the first n-dimensional logical space, a second n-dimensional logical space, and a physical memory space according to the one or more n-dimensional block indices, via the DMA engine, wherein n is greater than two. Preferably, the method further comprises providing an instruction memory comprising one or more special-purpose instructions which include one or more operations for n-dimensional data processing, providing an SIMD computation unit which is responsive to the one or more special-purpose instructions, and performing the one or more n-dimensional data processing upon at least one of two n-dimensional operands, via the SIMD computation unit. Preferably, the instruction memory further comprises one or more scalar instructions, and the method further comprises providing an SISD computation unit which is responsive to the one or more scalar instructions and performing one or more scalar operations upon at least one of two scalar operands, via the SISD computation unit.

### BRIEF DESCRIPTION OF THE DRAWINGS

FIG. 1 shows a schematic diagram of a microprocessor, comprising a DMA engine, memory including cache memory, SIMD and SISD computation units according to a preferred embodiment.

FIG. 2 shows a schematic diagram illustrating the mapping between memory and matrix registers for memory access instructions to matrix data according to a preferred embodiment.

FIG. 3 shows a schematic diagram of the mapping and distribution of data blocks between a first logical plane and memory space via the DMA engine according to a preferred embodiment.

FIG. 4 shows a flowchart which illustrates a typical decoding process of an inter-coded frame.

### DETAILED DESCRIPTION OF THE PRESENTLY PREFERRED EMBODIMENTS

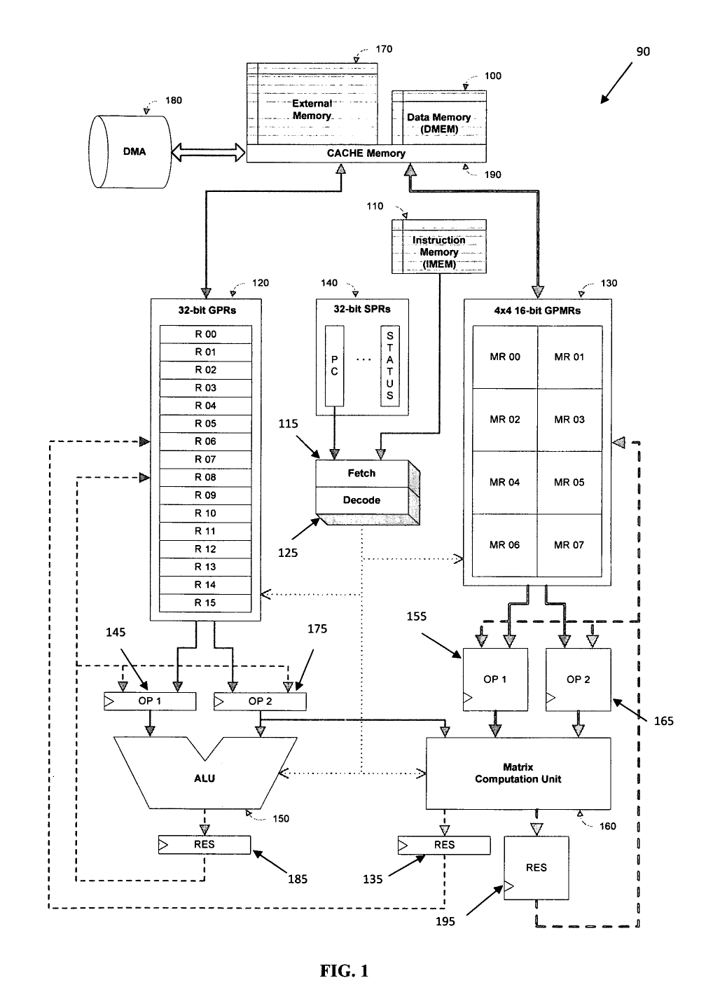

FIG. 1 depicts a schematic diagram of a preferred embodiment of a microprocessor 90, including a DMA engine 180, external memory 170, data memory 100, cache memory 190, instruction memory 110, general purpose registers (GPRs) 120, special purpose registers (SPRs) 140, general purpose matrix registers (GPMRs) 130, matrix operands 155 and 165, SIMD computation unit 160, scalar result register 135, matrix result register 195, scalar operands 145 and 175, SISD computation unit 150, and scalar result register 185. The microprocessor 90 of the present invention may be utilized as a special purpose processor for image or video processing and coding. In particular, the microprocessor 90 of the present invention may be utilized in mobile devices with low power consumption requirement.

The DMA engine 180, as known to artisans of ordinary skill, controls data transfers without subjecting the central processing unit (CPU) to heavy overhead. In particular, the DMA engine 180 of the present invention operates to manage data transfers between logical planes and memory space in such a way as to further reduce the overhead by responding to pairs of block indices associated with one or more blocks of data. According to one embodiment, the data blocks represent a single frame of a video sequence or a part thereof. For instance, in block motion compensation, known to artisans of ordinary skill, every frame of a video is partitioned into blocks of pixels. As an illustrative example, consider the MPEG standard. Every frame is partitioned into macroblocks of 16×16 pixels. Each one of these blocks is predicted from a block of equal size in a reference frame. Each such block is shifted to a new position of the predicted block which is represented by a motion vector. Accordingly, extensive data transfers occur within the memory space of the processor. The DMA engine 180 of the microprocessor 90 of the present invention dramatically reduces the number of operations that would otherwise be required by conventional microprocessors to handle such data transfers.

According to a preferred embodiment, the DMA engine 180 of the present invention operates on blocks of 4×4 pixels, each such block is identified by a pair of block indices which will be explained in more detail in relation to FIG. 3. As such, the DMA engine 180 provides a special operational mode that extends the concept and functionality of conventional 1D memory access to more efficient and natural 2D access for two-dimensional data processing. Although, the operation of the microprocessor 90 and specifically the DMA engine 180 has been described using 2D data fields, the concept is readily extended to n-dimensional data fields and specifically n-dimensional blocks of data.

### Memory and Registers

The external memory 170 of the microprocessor 90 of the present invention may be any memory space used to store data and/or instructions. In particular, the external memory 170 may be a mass storage device such as a flash memory, an external hard disc, or a removable media drive such as a CD-RW or DVD-RW drive. According to a preferred embodiment, the external memory 170 is of a type that stores data which may be accessed via a memory access instruction or the DMA engine 180.

The data memory 100 and instruction memory 110 may be any memory space. According to a preferred embodiment, the data memory 100 and instruction memory 110 are of the primary storage type such as ROM or RAM, known to artisans of ordinary skill. In one instance, the data memory 100 and instruction memory 110 are physically separated in the microprocessor 90 of the present invention. The instruction memory 110 may be loaded with the program to be executed by the microprocessor 90, in the form of a group of ordered instructions. On the other hand, the data memory 100 and the external memory 170 may be loaded with data needed by the program, both of which may be accessed and modified by using either memory access instructions or the DMA engine.

Three sets of registers are provided in the microprocessor 90 of the present invention. According to a preferred embodiment, a set of sixteen 32-bit general purpose registers (GPRs) 120 is available which may be utilized for scalar operations by the SISD computation unit 150 via scalar operands 145 and 175, and result register 185, and further by the result register 135 associated with the SIMD computation unit 160. A set of eight 4×4 general purpose matrix registers (GPMRs) 130 is available which may be utilized for matrix operations by the SIMD computation unit 160 via matrix operands 155 and 165, and result register 195. These set of registers 120 and 130 may be utilized in various forms by different instructions stored in the microprocessor 90. Their values may be changed by the execution of instructions which use them as result registers such as the result registers 135, 185, and 195. This includes the memory access instructions, which may be used to load the registers 135, 185, and 195 with data that is stored in the external memory 170 and data memory 100. A set of 32-bit special purpose registers (SPRs) 140 is used to hold the status of the microprocessor 90. Among others, the set of special purpose registers 140 may include a program counter register and a status register, known to artisans of ordinary skill. The program counter register, or PC, holds the address of the instruction being executed, and thus indicates where the microprocessor 90 is within its instructions sequence. On the other hand, the status register, as its name indicates, holds the current hardware status, including the zero, carry, overflow and negative flags.

### Computation Units and Reduced Instruction Set

A reduced instruction set has been designed for the microprocessor 90 which contains three different types of 32-bit instructions. The instruction set includes instructions for scalar operands and result such as for the scalar operands 145 and 175 and scalar result 185 associated with the SISD computation unit 150, instructions for 4×4 matrix operands and result such as for the matrix operands 155 and 165 and matrix result 195, and finally mixed instructions for cross combinations of scalar and 4×4 matrix operands and result such as the aforementioned scalar and matrix operands 145, 175, 155, 165, and scalar and matrix results 185, 135, and 195. Whereas each instruction, depending on its nature, may activate one or more of the four processor flags, all of them can be conditionally executed based on the sixteen combinations of these flags.

According to one preferred embodiment, the microprocessor 90 is configured such that during the first two stages of the five stage execution pipeline implemented by the microprocessor 90, namely fetch 115 and decode 125 of the instruction, the type of instruction, operands, and result is automatically determined. Based on this determination, the appropriate computation unit from the two available computation units, namely, SISD computation unit 150 and SIMD computation unit 160 is selected. The SISD computation unit 150 may be used by instructions exclusively involving scalar operands and result, such as the scalar operands 145 and 175 and scalar results 185. The SIMD computation unit 160 may be used for all the remaining instructions in the reduced instruction set, i.e., instructions with 4×4 matrix operands and result, such as the matrix operands 155 and 165 and matrix result 195, and instructions with combinations of scalar and 4×4 matrix operands 145, 175, 155, 165 and either scalar or 4×4 matrix result 135, 185, and 195. In all cases, scalar operands and results are held by the 32-bit general purpose registers 120, and matrix operands and results are held by the general purpose matrix registers 130.

Most of the instructions included in the reduced instruction set of the microprocessor 90 take a single clock cycle to be executed, and the few existing exceptions take no longer than five clock cycles. The fact that a 4×4 matrix computation, which involves sixteen pairs of scalar operands, can be carried out in such a small amount of clock cycles is one of the key features of the microprocessor 90, which boosts up its performance when processing two-dimensional (2D) data by a factor of up to 16. Such feature is especially relevant in the areas of image and video processing and coding given that the reduced instruction set of the microprocessor 90, in addition to instructions for conventional matrix operations such as addition, subtraction, transpose, absolute value, insert element, extract element, rotate columns/rows, merge, and more, also includes certain instructions specifically designed to perform key operations in those areas. Among these special instructions, the most remarkable ones are shown in Table 1. Those skilled in the art will indeed recognize the instructions listed below as key operations required in several core modules within typical image and video processing and coding applications.

TABLE 1

| Mnemonic | Description | Operation |
|---|---|---|
| MMULT | Multiply | ${mz}_{ij} = {\sum }_{k} {mx}_{ik} \cdot {my}_{kj}$ |
| | Multiply with Accumulation | ${macc}_{ij} = {macc}_{ij} + {\sum }_{k} {mx}_{ik} \cdot {my}_{kj}$ |
| MSCALE | Scale | mzᵢⱼ = {myᵢⱼ, K} · mxᵢⱼ |
| MCLIP | Clip | mzᵢⱼ = {min, max}(mxᵢⱼ, {myᵢⱼ, C}) |
| MMOVR | Shift-Right with | mzᵢⱼ = clip({0, 2^{S-1}}, |
| | Rounding/Truncation | (mxᵢⱼ[+2^{L-1}]) >> L, 2^{S-1} − 1) |
| | towards −∞ and Clip | |
| MMOVL | Shift-Left | mzᵢⱼ = mxᵢⱼ >> L |
| MSUM | Elements Summation | $S = {\sum }_{ij} {mx}_{ij}$ |
| MMIN | Minimum Element | e = min(mxᵢⱼ) |
| MMAX | Maximum Element | E = max(mxᵢⱼ) |
| MREORD | Elements Reorder | mzᵢⱼ = mx_{my}_{ᵢⱼ} |

For instance, MMULT and MMOVR are specially suited for direct and inverse 2D transforms, such as the discrete cosine transform (DCT), convolution used in filtering processes, and similar operations; MSCALE is useful for data scaling and quantization; MSUM is convenient to compute typical block distance measures, such as the SAD used by the block matching module in video codecs and similar; MMIN and MMAX are useful for decision-making within modules such as block matching and similar as well; finally, MREORD offers a very high degree of flexibility when performing direct and inverse block scans.

As an illustrative example, let us consider the case of Windows Media Video 9 codec (WMV9), and more specifically the case of its inverse transform module. Given an input 4×4 block D of inverse quantized transform coefficients, with values in a signed 12-bit range of [−2048 . . . 2047], the inverse transform module has to compute the output 4×4 block R of inverse transformed coefficients, with values in a signed 10-bit range of [−512 . . . 511], according to the following equations:

E=(D·F+4)>>3

R=(F^{T}·E+64)>>7

where E is the 4×4 block of intermediate values, in a signed 13-bit range of [−4096 . . . 4095], and F is the constant inverse transform matrix with values between −16 and 16. Looking carefully at the above equations, it can be seen that, for each of the 16 elements in the input 4×4 block D, a total of 4 instructions, namely multiply, add, shift-right and clip, would generally need to be repeated twice by any conventional processor in order to perform the inverse transform, leading to a total number of 128 instructions per input block. Then, assuming under ideal conditions that each of those instructions only takes one cycle to be executed, a total of 128 cycles would generally be consumed by a conventional processor in order to perform the inverse-transform on each input block.

On the other hand, the instruction set of the microprocessor 90 makes it possible to complete the inverse-transform of each input block with no more than 4 instructions, as it is shown below, where registers m0, m1 and m2 are originally loaded with the input block D, matrix F, and matrix F transposed respectively, −R indicates rounding, and the resulting inverse-transformed block is stored in register m3:
MMULT m3 m0 m1
MMOVR m3 m3 −R #3
MMULT m3 m2 m3
MMOVR m3 m3 −R #7

Given that MMOVR and MMULT instructions, under the worst case scenario, take a maximum of 1 and 5 cycles to be executed respectively, the microprocessor 90 would spend a maximum of 12 cycles to complete the inverse transform on each input block, which means that the microprocessor 90 is generally able to outperform conventional processors by a factor of at least 10 when considering the current illustrative sample application. Similar results can be obtained when considering other examples.

### Memory Access

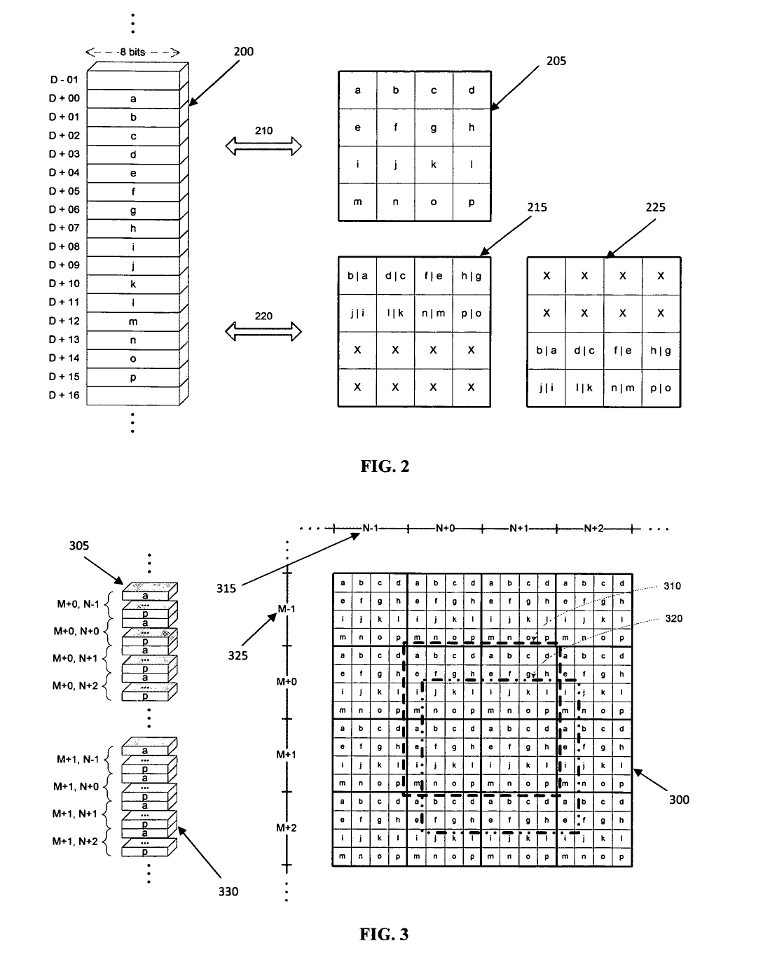

FIG. 2 depicts a schematic diagram illustrating two different types of mappings 210 and 220, between memory 200 and matrix registers 205, 215, and 225 for memory access instructions to matrix data according to a preferred embodiment. Another key feature of the microprocessor 90 resides in its capability to efficiently access, i.e., read and write two-dimensional (2D) data in memory 200. Within the aforementioned reduced instruction set, instructions for low-latency access (read and write) to matrix data in memory 200 are also provided in addition to instructions for regular access to conventional one-dimensional (1D) data (8, 16 and 32 bits). In FIG. 2, the two available memory access types for matrix structures are shown. Both memory access types 210 and 220 have in common an access unit of 128 bits. The difference lies in the way data is mapped from memory 200 to matrix registers 205, 215, and 225 and vice versa whenever a data is loaded/written from/to memory 200.

Memory access type 210 is used when data elements contained in the matrix are one byte wide. In such case, as shown in FIG. 2, sixteen consecutive bytes in memory 200 are directly mapped to the sixteen cells in the matrix register 205 following a raster scan order. When data is loaded from memory 200 to the matrix register 205, elements are zero-extended to sixteen bits, and on the contrary, when data is written from the matrix register 205 to memory 200, only the least significant byte of each element in the matrix is actually written.

On the other hand, memory access type 220 is used when data elements contained in the matrix are two bytes wide. In such a case, eight consecutive pairs of bytes in memory 200 are mapped in little-endian mode to either the top or bottom eight cells in the matrix registers 215 or 225 following a raster scan order and without altering the remaining eight cells.

### DMA Engine and Cache Memory

In a similar way as the matrix computation unit 160 extends the concept and functionality of conventional scalar computation units to a two-dimensional space, the DMA engine 180 and the cache memory 190 available in the microprocessor 90 also include special operational modes to extend the concept and functionality of conventional 1D memory access to more efficient and natural 2D access to two-dimensional data.

The basic purpose of the DMA engine 180 is to move (or transfer) data, generally big sets of data, between different locations in any of the memories of the system without the continuous and dedicated involvement of any of the computation units 150 and 160. A typical application of the DMA engine 180, but neither the only one nor the most important one, is to move data from an external memory such as the external memory 170, usually of big size and high latency access, to an internal or local memory such as the data memory 100, usually of small size and low-latency access.

The DMA engine 180 available in the microprocessor 90, in addition to a normal mode for regular 1D data transfers, also includes a mode specifically designed to efficiently handle 2D data transfers. Whereas conventional 1D DMA transfers are programmed based on sets of contiguous data in the 1D memory space, 2D DMA transfers are programmed based on two-dimensional sets of 4×4 blocks, of any arbitrary size, in a 2D logical plane, which in last instance is implicitly mapped to the 1D memory space.

FIG. 3 shows a typical example of such distribution of blocks in a logical plane 300, and the way they are mapped to memory space 305. Cells in each block are linearly mapped to memory 305 following a raster scan order, and in turn, blocks in the logical plane 300 are linearly mapped to memory 305 following a raster scan order as well. Notice that two-dimensional sets of blocks in the logical plane 300 generally correspond to multiple non-contiguous data segments in memory 305, which are hard to handle with conventional 1D DMA transfers.

The control information provided to program the DMA engine 180 for 2D DMA transfers, which is expressed in terms of pairs of block indices such as the indices 315 and 325 within the 2D logical plane 300, is automatically converted by the DMA engine 180 into multiple and more complex control information necessary to carry out the underlying 1D DMA transfers. In systems working with 2D data, this provides a major performance gain compared to conventional implementations where only 1D DMA transfers can be programmed, given that the conversion from 2D to 1D of DMA transfers control information is complex and has to be carried out by firmware, making exhaustive use of the computation units.

The 2D mode of the DMA engine 180 in the microprocessor 90 is able to carry out transfers of any continuous two-dimensional set of 4×4 blocks, in any of the following ways:
1. From a block-aligned 310 or non-block-aligned 320 location in the logical plane 300, to a different block-aligned or non-block-aligned location in the same or a different logical plane.
2. From a block-aligned 310 or non-block-aligned 320 location in the logical plane 300, to an arbitrary location in memory 305 where blocks are sequentially copied contiguous to each other.
3. From an arbitrary location in memory 305 where blocks are sequentially ordered and contiguous to each other, to a block-aligned 310 or non-block-aligned 320 location in the logical plane 300.

As an illustrative example of the applicability of the 2D DMA mode of the DMA engine 180, let us consider the motion compensation module in any of the best-known video codecs, such as H264, WMV9, RV9 and others. As known to artisans of ordinary skill, motion compensation is based on the idea that video frames that are consecutive in time usually show little differences, which are basically due to motion of objects present in the scene, and thus a high level of redundancy is present. Motion compensation aims to exploit for coding purposes such characteristic of most video sequences by creating an approximation (or prediction) of each video frame with blocks copied from collocated areas in past (or reference) frames. Changes of position of these blocks within the frame aim to effectively capture the motion of objects in the scene and are represented by the so-called motion vectors. The term motion estimation is generally used to refer to the process of finding the best motion vectors in the encoder, whereas motion compensation is generally used to refer to the process of using those motion vectors to create the predicted frame in the decoder.

Practical implementations of the motion estimation and compensation modules generally allocate the current and reference frames in memory such as the memory 305, and thus typically involve the movement of significant amounts of blocks between different memory locations. The main problem that conventional processors face, as has already been explained, is the fact that blocks, or two-dimensional sets of blocks, in frames typically correspond to multiple non-contiguous segments of data in the memory 305, due to the 2D to 1D conversion.

The 2D mode available in the DMA engine 180 of the microprocessor 90 overcomes the above problem by operating on a 2D logical plane such as the logical plane 300 that is implicitly mapped to the 1D memory space such as the memory space 305, rather than operating directly on the memory itself. The 2D logical plane, in this example, is used to represent frames, and the DMA transfers of blocks are directly programmed by means of the vertical and horizontal indices, such as the indices 315 and 325 of the blocks involved, as shown in FIG. 3. The DMA engine 180 automatically takes care of translating all this 2D indexing information into the corresponding and more complex 1D indexing information suitable for memory access.

Finally, jointly working with the 2D memory access and the 2D DMA transfers, the microprocessor 90 includes a cache memory such as the cache memory 190 for two-dimensional sets of data as well, in addition to the regular 1D cache. This 2D cache is specifically designed to improve the performance of the memory access to 4×4 blocks of data within the logical plane introduced above.

The 2D cache 190 dynamically updates its content with copies of the 4×4 blocks of data from the most frequently accessed locations within the logical plane 300. Since the 2D cache has lower latency than regular local and external memories such as the external memory 170 and data memory 100, it speeds up the memory accesses to 2D data as long as most of these are performed to cached blocks (cache hit).

Typical allocation, extraction and replacement policies of cache memories, as known to artisans of ordinary skill, work based on the definition of regions of data that are more likely to be accessed than others, and on proximity and neighborhood criteria. It is important to notice that the above measures and criteria that are used by conventional 1D cache memories show very clear limitations when dealing with two-dimensional distributions of data, given the discontinuity issues that have already been pointed out during the 2D to 1D conversion, which make the 1D proximity and neighborhood criteria inefficient to work on a 2D space. Instead, the 2D cache of the microprocessor 90 operates based on two-dimensional indices, such as the indices 315 and 325 of blocks in the logical plane 300 to define such measures and criteria, which significantly increases the cache hits. According to one preferred embodiment, the content of cache memory 190 of the microprocessor 90 is updated according to a neighborhood of a particular block which includes 8 neighboring blocks.

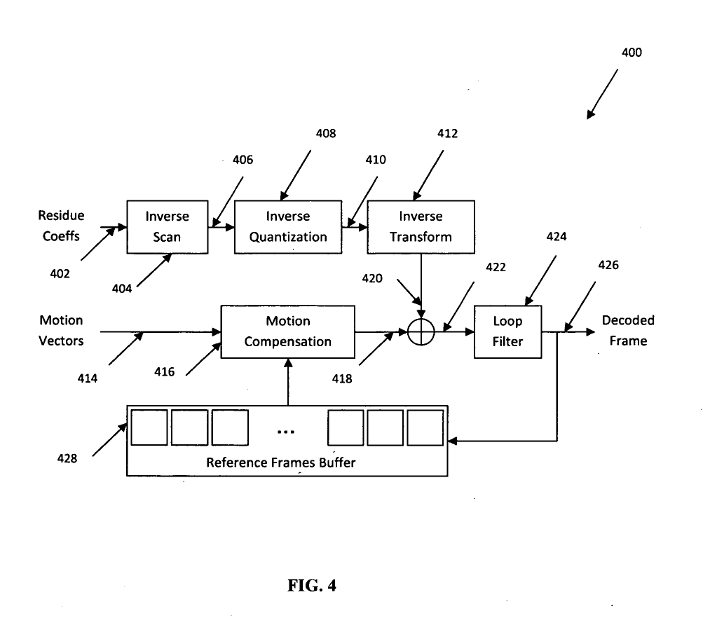

Utilizing FIGS. 1-4 described above, one embodiment of the operation of the microprocessor 90 is now described. Let us consider FIG. 4 which illustrates a typical decoding process of an inter-coded frame, and includes the very basic blocks that are part of any of the most important video decoders:

The top branch is responsible for building the error frame, using as input the residue coefficients 402. The residue coefficients 402 are obtained from variable-length decoding of the corresponding syntax elements in the coded video stream, which does not require any specific matrix operation and can be efficiently implemented with a conventional scalar processor.

On the other hand, the bottom branch is responsible for building the prediction frame, using as input the motion vectors 414 and certain number of previously decoded frames that are stored in the reference frames buffer 430. Motion vectors are also obtained from variable-length decoding of the corresponding syntax elements in the stream.

The error and prediction frames are added together in order to obtain the reconstructed frame, which is then filtered in order to reduce blockiness in the final decoded frame 426. The decoded frame 426 is finally stored in the reference frames buffer 428 for future use during prediction.

Frames are generally partitioned into macroblocks, which are usually defined as blocks of 16×16 pixels, and the process described above is generally performed macroblock by macroblock. Referring to FIG. 4, the following illustrates how the microprocessor 90 speeds up the decoding process:
1. Inverse Scan 404: the residue coefficients 402 corresponding to a macroblock are normally ordered (in the stream) following some type of zig-zag scan of the macroblock, or, in general, of any sub-partition (block) of the macroblock. Different video codecs use different zig-zag scans, but the basic idea is to scan the coefficients from higher to lower energy, and thus from coefficients that are more likely to be non-zero to those others that are more likely to be zero, so that the encoder can decide when to stop sending coefficients within a macroblock or block, given that it is known that all the remaining coefficients, following that scan order, are zero. The decoder has to inverse-scan 404 the residue coefficients 402 in order to place them in the right final position within the macroblock or block. The microprocessor 90 can perform the inverse (and direct) scan on a 4×4 block with a single instruction such as MREORD. One matrix operand, for instance the matrix operand 155 contains the residue coefficients 402 in their original order, i.e. they are placed in the matrix operand following a raster scan order as they are received in the stream. A second matrix operand, the matrix operand 165 is loaded with the relocation mapping that needs to be used for a given scan order. Subsequently the result is a matrix, such as the result matrix 195, which contains the residue coefficients relocated according to the provided mapping. A representative example is shown below:

$${\begin{matrix}A & B & C & D \\ E & F & G & H \\ I & J & K & L \\ M & N & O & P\end{matrix}}_{{m 0}_{Residue Coeffs}} {{\begin{matrix}0 & 1 & 5 & 6 \\ 2 & 4 & 7 & 12 \\ 3 & 8 & 11 & 13 \\ 9 & 10 & 14 & 15\end{matrix}}^{MREORD m 2 m 0 m 1}}_{{m 1}_{Relocation Mapping}} {\begin{matrix}A & B & F & G \\ C & E & H & M \\ D & I & L & N \\ J & K & O & P\end{matrix}}_{{m 2}_{Inverse \text{-} Scanned Block}}$$

Scans defined based on blocks bigger than 4×4 can be implemented with multiple scans of 4×4 blocks.
2. Inverse Quantization 408: for each pixel, this block maps from certain index value of the residue coefficient to the final level value of that residue coefficient. This operation is normally a combination of scaling, addition, and shift, which can be implemented for each 4×4 block using MSCALE, MADD, MMOVR and MMOVL instructions. A representative sample equation for the inverse quantization could be:

LEVEL=(QP·INDEX+8)>>4
where QP is the quantization parameter. The above operation can be implemented as shown below, where registers m0 and r0 are originally loaded with the block of indices and QP respectively, −R indicates rounding, and the resulting block of inverse-quantized residue coefficients is stored in register m1:
   MSCALE m1 m0 r0
   MMOVR m1 m1 −R #4
3. Inverse Transform 412: once the level values of the residue coefficients are found, these must be inverse-transformed in order to obtain the final error values of the pixels. This is a block operation that typically involves multiplication, right-shift, rounding/truncation, and clipping, which can be implemented for each 4×4 block using MMULT and MMOVR.
4. Motion Compensation 416: this is a key module in the decoding process of a inter-coded frame, typically requiring most of the processor power. It basically involves memory access to blocks of pixels within the reference frames. To simplify, given a certain partition of macroblocks into blocks within the current frame, the basic idea behind motion compensation is to use ‘similar’ blocks in any of the reference frames, and in any arbitrary location within that reference frame (in general non-block-aligned, such as the non-block-aligned 320), as prediction for blocks in the current frame. Motion vectors 414 precisely indicate where those ‘similar’ blocks are located. Therefore, in order to obtain the prediction blocks, the video decoder generally has to access a different location (in general non-block-aligned 320) within the reference frames buffer 428 for each block in the current frame. The reference frames buffer 428 is typically allocated in an external memory, such as the external memory 170, 200, or 305, given that it requires a significant amount of space. Using the microprocessor 90, one can set up a logical plane, such as the logical plane 300, for each frame in the reference frames buffer, and then use the 2D DMA mode of the DMA engine 180 to fetch the desired blocks from the reference frames buffer (external memory) and bring them into the local memory such as the data memory 100, where they can be easily handled and loaded into matrix registers 130 for any further processing required to build the final prediction. It is also important to notice that the motion vectors of neighboring blocks in the current frame usually point to neighboring blocks in the reference frames, and 2D cache takes advantage of such fact in order to speed up the 2D DMA access to the reference blocks. Once the final prediction block is obtained for each block in the current frame, it can be added (MADD) to the corresponding inverse-transformed block in order to obtain the reconstructed block.
5. Loop Filter 424: this module is usually the last stage before obtaining the final decoded frame. It generally performs some type of content-aware low-pass filtering across the block edges on the reconstructed frame. A representative example of such filtering operation could be:

D=(R·U+V+4)>>3
where R is the reconstructed block, U is the filtering matrix and V is an offset matrix. The above operation can be implemented as shown below, where registers m0, m1 and m2 are originally loaded with the reconstructed block, matrix U, and matrix V respectively, −R indicates rounding, and the resulting decoded block is stored in register m3:
   MMULT m3 m0 m1
   MADD m3 m3 m2
   MMOVR m3 m3 −R #3
6. Store Decoded Frame 426: once a macroblock is completely decoded, and usually stored somewhere in local memory, it has to be stored in the reference frames buffer 428, in its corresponding location within the current frame, for future use as prediction frame. Once again, this can be done using 2D DMA transfers, this time from local memory to the logical plane corresponding to the current frame in the reference frames buffer 428 (external memory).

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A microprocessor, comprising:
a direct memory access (DMA) engine responsive to one or more pairs of block indices associated with one or more blocks in a first logical plane and operative to transfer the one or more blocks, to/from at least one of the first logical plane, a second logical plane, and a physical memory space according to the one or more pairs of block indices.

2. The microprocessor of claim 1, wherein each of the one or more pairs of block indices correspond to a horizontal and vertical location of one of the one or more blocks in the first logical plane.

3. The microprocessor of claim 2, wherein the horizontal and vertical location correspond to one of a block-aligned and a non-block-aligned locations, and wherein the block-aligned location locates an aligned block whose elements are contiguous in the physical memory space, and wherein a non-block-aligned location locates a non-aligned block whose elements are non-contiguous in the physical memory space.

4. The microprocessor of claim 3, wherein the DMA engine is configured to transfer one or more aligned blocks in the first logical plane to the physical memory space.

5. The microprocessor of claim 3, wherein the DMA engine is configured to transfer one or more blocks from the physical memory space to one or more aligned blocks in the first logical plane.

6. The microprocessor of claim 3, wherein the DMA engine is configured to transfer one or more non-aligned blocks in the first logical plane to the physical memory space.

7. The microprocessor of claim 3, wherein the DMA engine is configured to transfer one or more blocks from the physical memory space to one or more non-aligned blocks in the first logical plane.

8. The microprocessor of claim 3, wherein the DMA engine is configured to transfer one or more aligned blocks in the first logical plane to one or more non-aligned blocks in the first logical plane.

9. The microprocessor of claim 3, wherein the DMA engine is configured to transfer one or more aligned blocks in the first logical plane to one or more aligned blocks in the first logical plane.

10. The microprocessor of claim 3, wherein the DMA engine is configured to transfer one or more non-aligned blocks in the first logical plane to one or more aligned blocks in the first logical plane.

11. The microprocessor of claim 3, wherein the DMA engine is configured to transfer one or more non-aligned blocks in the first logical plane to one or more non-aligned blocks in the first logical plane.

12. The microprocessor of claim 3, wherein the DMA engine is configured to transfer one or more aligned blocks in the first logical plane to one or more aligned blocks in the second logical plane.

13. The microprocessor of claim 3, wherein the DMA engine is configured to transfer one or more aligned blocks in the first logical plane to one or more non-aligned blocks in the second logical plane.

14. The microprocessor of claim 3, wherein the DMA engine is configured to transfer one or more non-aligned blocks in the first logical plane to one or more non-aligned blocks in the second logical plane.

15. The microprocessor of claim 3, wherein the DMA engine is configured to transfer one or more non-aligned blocks in the first logical plane to one or more aligned blocks in the second logical plane.

16. The microprocessor of claim 1, wherein each of the one or more blocks is a four-by-four-element matrix.

17. The microprocessor of claim 16, wherein each element of the four-by-four-element matrix is an eight-bit data.

18. The microprocessor of claim 1, wherein the first logical plane, second logical plane, and physical memory space comprise at least one of an external memory and internal memory.

19. The microprocessor of claim 1, further comprising cache memory responsive to the transfer of the one or more blocks and operative to update its content with one or more cache-blocks associated with the one or more blocks.

20. The microprocessor of claim 19, wherein the one or more cache-blocks are in the neighborhood of the one or more blocks.

21. The microprocessor of claim 20, wherein the neighborhood of one of the one or more blocks comprises 8 blocks adjacent to the one of the one or more blocks in any of the logical planes.

22. The microprocessor of claim 1, further comprising:
an instruction memory comprising one or more special-purpose instructions, wherein the one or more special-purpose instructions comprise one or more matrix operations; and
a single-instruction-multiple-data (SIMD) computation unit responsive to the one or more special-purpose instructions and operative to perform the one or more matrix operations upon at least one of two matrix operands.

23. The microprocessor of claim 22, wherein the SIMD is configured to execute each of the one or more special-purpose instructions in less than or equal to five clock cycles.

24. The microprocessor of claim 22, wherein the one or more matrix operations comprise matrix operations performed in at least one of image and video processing and coding.

25. The microprocessor of claim 22, wherein the at least one of two matrix operands is a four-by-four matrix operand whose elements are each sixteen bits wide.

26. The microprocessor of claim 22, wherein the instruction memory further comprises one or more scalar instructions and wherein the microprocessor further comprises:
a single-instruction-single-data (SISD) computation unit responsive to the one or more scalar instructions and operative to perform one or more scalar operations upon at least one of two scalar operands.

27. The microprocessor of claim 26, wherein the SIMD computation unit is further operative to receive scalar operands from the SISD computation unit to be utilized in the one or more matrix operations.

28. The microprocessor of claim 26, wherein the SISD computation unit is further operative to receive scalar operands from the SIMD computation unit to be utilized in the one or more scalar operations.

29. A microprocessor, comprising:
a direct memory access (DMA) engine responsive to one or more n-dimensional block indices associated with one or more n-dimensional blocks in a first n-dimensional logical space and operative to transfer the one or more n-dimensional blocks, to/from at least one of the first n-dimensional logical space, a second n-dimensional logical space, and a physical memory space according to the one or more n-dimensional block indices, wherein n is greater than two.

30. The microprocessor of claim 29, further comprising cache memory responsive to the transfer of the one or more n-dimensional blocks and operative to update its content with one or more n-dimensional cache-blocks associated with the one or more n-dimensional blocks.

31. The microprocessor of claim 29, further comprising:
an instruction memory comprising one or more special-purpose instructions, wherein the one or more special-purpose instructions comprise one or more operations for n-dimensional data processing; and
a single-instruction-multiple-data (SIMD) computation unit responsive to the one or more special-purpose instructions and operative to perform the one or more n-dimensional data processing upon at least one of two n-dimensional operands.

32. The microprocessor of claim 31, wherein the instruction memory further comprises one or more scalar instructions and wherein the microprocessor further comprises:
a single-instruction-single-data (SISD) computation unit responsive to the one or more scalar instructions and operative to perform one or more scalar operations upon at least one of two scalar operands.

33. A method of processing data via a microprocessor, comprising:
(a) providing a direct memory access (DMA) engine responsive to one or more pairs of block indices associated with one or more blocks in a first logical plane; and
(b) transferring the one or more blocks, to/from at least one of the first logical plane, a second logical plane, and a physical memory space according to the one or more pairs of block indices, via the DMA engine.

34. The method of claim 33, wherein the microprocessor further comprises cache memory responsive to the transferring of the one or more blocks, said method further comprising:
(c) updating a content of the cache memory with one or more cache-blocks associated with the one or more blocks, via the microprocessor.

35. The method of claim 33, further comprising:
(c) providing an instruction memory comprising one or more special-purpose instructions, wherein the one or more special-purpose instructions comprise one or more matrix operations;
(d) providing a single-instruction-multiple-data (SIMD) computation unit responsive to the one or more special-purpose instructions; and
(e) performing the one or more matrix operations upon at least one of two matrix operands, via the SIMD computation unit.

36. The method of claim 35, wherein the instruction memory further comprises one or more scalar instructions, said method further comprising:
(f) providing a single-instruction-single-data (SISD) computation unit responsive to the one or more scalar instructions; and
(g) performing one or more scalar operations upon at least one of two scalar operands, via the SISD computation unit.

37. The method of claim 36, further comprising
(h) receiving scalar operands, via the SIMD computation unit from the SISD computation unit to be utilized in the one or more matrix operations.

38. The method of claim 36, further comprising,
(h) receiving scalar operands, via the SISD computation unit from the SIMD computation unit to be utilized in the one or more scalar operations.

39. A method of processing data via a microprocessor, comprising:
(a) providing a direct memory access (DMA) engine responsive to one or more n-dimensional block indices associated with one or more n-dimensional blocks in a first n-dimensional logical space; and
(b) transferring the one or more n-dimensional blocks, to/from at least one of the first n-dimensional logical space, a second n-dimensional logical space, and a physical memory space according to the one or more n-dimensional block indices, via the DMA engine, wherein n is greater than two.

40. The method of claim 39, wherein the microprocessor further comprises cache memory responsive to the transferring of the one or more n-dimensional blocks, said method further comprising:
(c) updating a content of the cache memory with one or more n-dimensional cache-blocks associated with the one or more n-dimensional blocks, via the microprocessor.

41. The method of claim 39, further comprising:
(c) providing an instruction memory comprising one or more special-purpose instructions, wherein the one or more special-purpose instructions comprise one or more operations for n-dimensional data processing;
(d) providing a single-instruction-multiple-data (SIMD) computation unit responsive to the one or more special-purpose instructions; and
(e) performing the one or more n-dimensional data processing upon at least one of two n-dimensional operands, via the SIMD computation unit.

42. The method of claim 41, wherein the instruction memory further comprises one or more scalar instructions, said method further comprising:
(f) providing a single-instruction-single-data (SISD) computation unit responsive to the one or more scalar instructions; and
(g) performing one or more scalar operations upon at least one of two scalar operands, via the SISD computation unit.
